(19) United States
(12) Patent Application Publication
(10) Pub. No.: US 2024/0061902 A1
(43) Pub. Date: Feb. 22, 2024

(54) SYSTEMS AND METHODS FOR FORMULATING A PREDICTION MODEL AND FOR USING THE SAME

(71) Applicants: Jiyoung IM, Kitchener (CA); Tyler WEAMES, Kitchener (CA); Yong ZHANG, Richmond (CA); Zirui ZHOU, Surrey (CA)

(72) Inventors: Jiyoung IM, Kitchener (CA); Tyler WEAMES, Kitchener (CA); Yong ZHANG, Richmond (CA); Zirui ZHOU, Surrey (CA)

(21) Appl. No.: 18/449,305

(22) Filed: Aug. 14, 2023

Related U.S. Application Data
(60) Provisional application No. 63/397,717, filed on Aug. 12, 2022.

(51) Int. Cl. G06F 17/12

(52) U.S. Cl. CPC G06F 17/12

(57) ABSTRACT

Systems and methods for formulating a prediction model. A linear prediction of an expert model is received, wherein given point xⁱ, the linear prediction is gⁱ:=g(xⁱ)=g^{T}xⁱ+g₀, the expert model having an expert model feature list. New data (xⁱ,yⁱ)∀i∈[1,N] is received, wherein the expert model feature list is a subset of a new feature list of the new data. The prediction model is formulated as

$${min}_{w} {\sum }_{i = 1}^{N} {( {f}^{i} ( w ) - {y}^{i} )}^{2} + {μ ( {f}^{i} ( w ) - {g}^{i} )}^{2} ,$$

wherein f^{x}(w)≤c₁, ∀x∈X, and f^{x}(w)≤c₃, ∀x∈X∩H. μ is a positive number assigning weight to the linear prediction.

### CROSS-REFERENCE TO RELATED APPLICATIONS

This application claims the benefit of U.S. Provisional Application No. 63/397,717 filed on Aug. 12, 2022, the entire contents of which are incorporated herein by reference.

### TECHNICAL FIELD

The present disclosure relates to modeling, and, in particular, to systems and methods for formulating a prediction model and for using the same.

### BACKGROUND

Many companies have collected data that reflects the accumulated expertise. Meanwhile, there is a newly accumulated set of data that reflects modern phenomena. Many organizations seek to find good prediction models that incorporate both the accumulated expertise as well as the modern phenomena.

However, the decision maker has an incomplete knowledge on the model parameters and only knows ranges (bounds) of the uncertain parameters lie in. Furthermore, once the prediction model is built, every realization of the uncertain parameter must satisfy certain restrictions imposed by the decision maker. This gives rise to a model with infinitely many constraints. This causes intractability issues of the model and the model cannot be solved using a standard software without further engineering.

### SUMMARY

In accordance with a first aspect of the present disclosure, there is provided a computer-implemented method for formulating a prediction model, comprising: one or more processors; a memory storing computer-executable instructions that, when executed by the one or more processors, cause the computing system to: receive a linear prediction of an expert model wherein given point xⁱ, the linear prediction is gⁱ:=g(xⁱ)=g^{T}xⁱ+g₀, the expert model having an expert model feature list; receive new data (xⁱ,yⁱ)∀i∈[1,N], wherein the expert model feature list is a subset of a new feature list of the new data; and formulate a prediction model as:

$${min}_{w} {\sum }_{i = 1}^{N} {( {f}^{i} ( w ) - {y}^{i} )}^{2} + {μ ( {f}^{i} ( w ) - {g}^{i} )}^{2} ,$$

wherein: f^{x}(w)≤c₁, ∀x∈X, and f^{x}(w)≤c₃, ∀x∈X∩H, and wherein μ is a positive number assigning weight to the linear prediction.

In some or all example embodiments of the first aspect, the computer-executable instructions, when executed by the one or more processors, cause the computing system to formulate the prediction model as a linear prediction model, fⁱ(w), set to fⁱ(w)=w^{T}xⁱ+w₀, f^{x}(w)=w^{T}x+w₀, with an objective function of: Σᵢ₌₁^{N}(w^{T}xⁱ+w₀−yⁱ)²+μ(w^{T}xⁱ+w₀−gⁱ)², and with the following constraints: type 1: w^{T}x+w₀≤c+β^{T}x, ∀x∈X, and type 2: w^{T}x+w₀≤c, ∀x∈X∩H.

In some or all example embodiments of the first aspect, the computer-executable instructions, when executed by the one or more processors, cause the computing system to formulate the prediction model as a quadratic prediction model, fⁱ(γ,q,Q), set to fⁱ(γ,q,Q)=γ+2q^{T}xⁱ+(xⁱ)^{T}Qxⁱ, f^{x}(γ,q,Q)=γ+2q^{T}x+(x)^{T}Qx, with an isometric realization

$${x}^{T} Qx + 2 {q}^{T} x + γ = 〈 [ \begin{matrix}γ & {q}^{T} \\ q & Q\end{matrix} ] , [ \begin{matrix}1 & {x}^{T} \\ x & x {x}^{T}\end{matrix} ] 〉 = 〈 W , {Y}_{x} 〉 = 〈 \tilde{w} , \tilde{x} 〉 ,$$

wherein \tilde{w}=svec(W), \tilde{x}=svec(Yₓ), wherein an objective function can be written as Σᵢ₌₁^{N}( [symbol] \tilde{w},\tilde{x}ⁱ [symbol] −yⁱ)²+μ( [symbol] \tilde{w},\tilde{x}ⁱ [symbol] −gⁱ)², and wherein the constraints can be written as type 1: [symbol] \tilde{w},\tilde{x} [symbol] ≤c₁+β^{T}x, ∀x∈X, and type 2: [symbol] \tilde{w},\tilde{x} [symbol] ≤c₃, ∀x∈X∩H.

In a second aspect of the present disclosure, there is provided a computer-implemented method for formulating a prediction model, comprising: receiving a linear prediction of an expert model wherein given point xⁱ, the linear prediction is gⁱ:=g(xⁱ)=g^{T}xⁱ+g₀, the expert model having an expert model feature list; receiving new data (xⁱ,yⁱ)∀i∈[1,N], wherein the expert model feature list is a subset of a new feature list of the new data; and formulating a prediction model as:

$${min}_{w} {\sum }_{i = 1}^{N} {( {f}^{i} ( w ) - {y}^{i} )}^{2} + {μ ( {f}^{i} ( w ) - {g}^{i} )}^{2} ,$$

wherein: f^{x}(w)≤c₁, ∀x∈X, and f^{x}(w)≤c₃, ∀x∈X∩H, and wherein μ is a positive number assigning weight to the linear prediction.

In some or all example embodiments of the second aspect, the prediction model is formulated as a linear prediction model, fⁱ(w), set to fⁱ(w)=w^{T}xⁱ+w₀, f^{x}(w)=w^{T}x+w₀, with an objective function of: Σᵢ₌₁^{N}(w^{T}xⁱ+w₀−yⁱ)²+μ(w^{T}xⁱ+w₀−gⁱ)², and with the following constraints: type 1: w^{T}x+w₀≤c+β^{T}x, ∀x∈X, and type 2: w^{T}x+w₀≤c, ∀x∈X∩H.

In some or all example embodiments of the second aspect, the prediction model is formulated as a quadratic prediction model, fⁱ(γ,q,Q), set to fⁱ(γ,q,Q)=γ+2q^{T}xⁱ+(xⁱ)^{T}Qxⁱ, f^{x}(γ,q,Q)=γ+2q^{T}x+(x)^{T}Qx, with an isometric realization

$${x}^{T} Qx + 2 {q}^{T} x + γ = 〈 [ \begin{matrix}γ & {q}^{T} \\ q & Q\end{matrix} ] , [ \begin{matrix}1 & {x}^{T} \\ x & x {x}^{T}\end{matrix} ] 〉 = 〈 W , {Y}_{x} 〉 = 〈 \tilde{w} , \tilde{x} 〉 ,$$

wherein \tilde{w}=svec(W), \tilde{x}=svec(Yₓ), wherein an objective function can be written as Σᵢ₌₁^{N}( [symbol] \tilde{w},\tilde{x}ⁱ [symbol] −yⁱ)²+μ( [symbol] \tilde{w},\tilde{x}ⁱ [symbol] −gⁱ)², and wherein the constraints can be written as type 1: [symbol] \tilde{w},\tilde{x} [symbol] ≤c₁+β^{T}x, ∀x∈X, and type 2: [symbol] \tilde{w},\tilde{x} [symbol] ≤c₃, ∀x∈X∩H.

In a third aspect of the present disclosure, there is provided a non-transitory machine-readable medium having tangibly stored thereon computer-executable instructions for execution by one or more processors, wherein the computer-executable instructions, in response to execution by the one or more processors, cause the one or more processors to: receive a linear prediction of an expert model wherein given point xⁱ, the linear prediction is gⁱ:=g(xⁱ)=g^{T}xⁱ+g₀, the expert model having an expert model feature list; receive new data (xⁱ,yⁱ)∀i∈[1,N], wherein the expert model feature list is a subset of a new feature list of the new data; and formulate a prediction model as:

$${min}_{w} {\sum }_{i = 1}^{N} {( {f}^{i} ( w ) - {y}^{i} )}^{2} + {μ ( {f}^{i} ( w ) - {g}^{i} )}^{2} ,$$

wherein: f^{x}(w)≤c₁, ∀x∈X, and f^{x}(w)≤c₃, ∀x∈X∩H, and wherein μ is a positive number assigning weight to the linear prediction.

In some or all example embodiments of the third aspect, the computer-executable instructions, when executed by the one or more processors, cause the computing system to formulate the prediction model as a linear prediction model, fⁱ(w), set to fⁱ(w)=w^{T}xⁱ+w₀, f^{x}(w)=w^{T}x+w₀, with an objective function of: Σᵢ₌₁^{N}(w^{T}xⁱ+w₀−yⁱ)²+μ(w^{T}xⁱ+w₀−gⁱ)², and with the following constraints: type 1: w^{T}x+w₀≤c+β^{T}x, ∀x∈X, and type 2: w^{T}x+w₀≤c, ∀x∈X∩H.

In some or all example embodiments of the third aspect, the computer-executable instructions, when executed by the one or more processors, cause the computing system to formulate the prediction model as a quadratic prediction model, , fⁱ(γ,q,Q), set to fⁱ(γ,q,Q)=γ+2q^{T}xⁱ+(xⁱ)^{T}Qxⁱ, f^{x}(γ,q,Q)=γ+2q^{T}x+(x)^{T}Qx, with an isometric realization

$${x}^{T} Qx + 2 {q}^{T} x + γ = 〈 [ \begin{matrix}γ & {q}^{T} \\ q & Q\end{matrix} ] , [ \begin{matrix}1 & {x}^{T} \\ x & x {x}^{T}\end{matrix} ] 〉 = 〈 W , {Y}_{x} 〉 = 〈 \tilde{w} , \tilde{x} 〉 ,$$

wherein \tilde{w}=svec(W), \tilde{x}=svec(Yₓ), wherein an objective function can be written as Σᵢ₌₁^{N}( [symbol] \tilde{w},\tilde{x}ⁱ [symbol] −yⁱ)²+μ( [symbol] \tilde{w},\tilde{x}ⁱ [symbol] −gⁱ)², and wherein the constraints can be written as type 1: [symbol] \tilde{w},\tilde{x} [symbol] ≤c₁+β^{T}x, ∀x∈X, and type 2: [symbol] \tilde{w},\tilde{x} [symbol] ≤c₃, ∀x∈X∩H.

Other aspects and features of the present disclosure will become apparent to those of ordinary skill in the art upon review of the following description of specific implementations of the application in conjunction with the accompanying figures.

### BRIEF DESCRIPTION OF THE DRAWINGS

FIG. 1 is a schematic diagram of a general approach to formulating a prediction model in accordance with example embodiments described herein.

FIG. 2 shows a high level overview of a problem form in accordance with example embodiments described herein.

FIG. 3 is a schematic diagram showing various physical and logical components of a computing system for formulating a prediction model and using the same in accordance with example embodiments described herein.

### DETAILED DESCRIPTION OF EXAMPLE EMBODIMENTS

The present disclosure is made with reference to the accompanying drawings, in which embodiments are shown. However, many different embodiments may be used, and thus the description should not be construed as limited to the embodiments set forth herein. Rather, these embodiments are provided so that this application will be thorough and complete. Wherever possible, the same reference numbers are used in the drawings and the following description to refer to the same elements, and prime notation is used to indicate similar elements, operations or steps in alternative embodiments. Separate boxes or illustrated separation of functional elements of illustrated systems and devices does not necessarily require physical separation of such functions, as communication between such elements may occur by way of messaging, function calls, shared memory space, and so on, without any such physical separation. As such, functions need not be implemented in physically or logically separated platforms, although such functions are illustrated separately for ease of explanation herein. Different devices may have different designs, such that although some devices implement some functions in fixed function hardware, other devices may implement such functions in a programmable processor with code obtained from a machine-readable medium. Lastly, elements referred to in the singular may be plural and vice versa, except wherein indicated otherwise either explicitly or inherently by context.

Models with two objectives with no constraints can incorporate complicated prediction models of higher orders. However, it is complicated to incorporate hard constraints imposed on the models. Furthermore, these models cannot incorporate uncertainty in the prediction model effectively.

The present disclosure describes example embodiments of methods, systems, and computer-executable media for modeling a problem by formulating a prediction model. In some embodiments, described is a strong tractable prediction model reformulation framework that avoids the intractability issue in modeling the problem. For example, it may represent the infinitely many restraints by using a finitely many number of restraints.

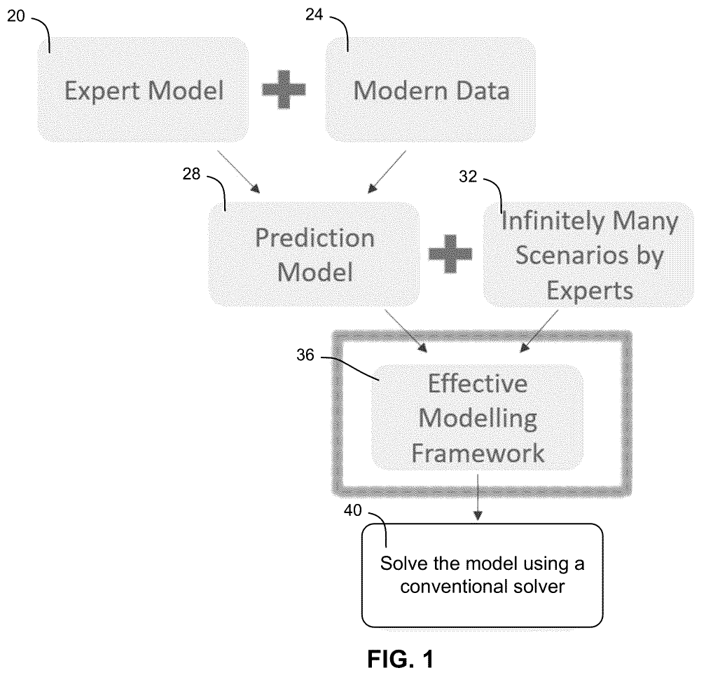

FIG. 1 shows a general approach for formulating a prediction model in accordance with an embodiment. An expert model 20 represents the knowledge of experts. Modern data 24 represents modern phenomena. A conventional prediction model 28 can be formulated from the expert model 20 and the modern data 24. There are, however, infinitely many scenarios or constraints 32 are imposed by a decision maker. The embodiments described herein may reformulate such prediction models using an effective modelling framework 36, after which the problem can be solved using a conventional solver 40.

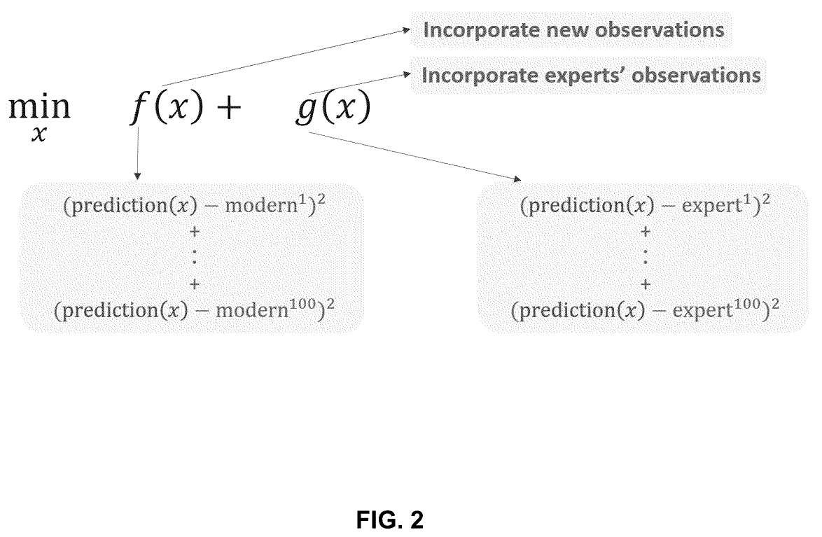

Modelling techniques involving two objectives often appear in many classes in mathematical programming. They often have the form “min[f(x)+g(x)]”, as shown in FIG. 2. The terms f(x) and g(x) are responsible for the first objective and the second objective, respectively. The goal of formulation is to achieve the middle ground of the two objectives.

An example of such a problem that can be modeled using the approach described herein is the combining of federated learning with a mechanism model. The first objective engages the federated learning. In federated learning, agents work collectively without exchanging the entire data in order to keep the data privacy. This can be modelled using a function f(x). The second objective engages the mechanism model. The mechanism model engages the knowledge collected by local experts. This can be modelled using a function g(x).

Semi-infinite programs (SIP) form a class of mathematical programs that handle problems with an infinitely many constraints and a finite number of variables. An approach to modeling such problems starts with the detection of the intractability of the model where the infinitely many constraints appear as the form of an uncertainty set. Second, the duality theory of mathematical programs is used to transform the intractable model into a solvable model and achieve tractability.

In order to demonstrate the application of this approach, an example of a tractable transformation is provided. Suppose that variables x₁ and x₂ must satisfy

c₁x₁+c₂x₂≤40, for all c₁,c₂ in range 0≤c₁≤2, 0≤c₂≤10 (1)

This is intractable because there are infinitely many choices for c.

Equivalently, equation (1) has representation

$${max}_{{c}_{1} , {c}_{2}} \{ {c}_{1} {x}_{1} + {c}_{2} {x}_{2} subject to 0 ≦ {c}_{1} ≦ 2 , 0 ≦ {c}_{2} ≦ 10 \} ≦ 40 , \qquad ( 2 )$$

for fixed x₁, x₂.

Using the duality theory, equation (2) can be reworked as a set of inequalities with new variables v₁, v₂.

2v₁+10v₂≤40, v₁≥0, v₂≥0, v₁=x₁, v₂=x₂ (3)

Three inputs are used in modeling the problem: a mechanism (or expert) model, modern data, and constraints on the prediction.

The mechanism model is assumed to be a linear prediction model given by experts for simplicity purposes. Given point xⁱ, the expert's prediction is gⁱ=g(xⁱ)=g^{T}xⁱ+g₀.

In modern data, a new set of data can have more features than the traditional mechanism model. Modern data is represented by (xⁱ,yⁱ), where i runs from 1 to N, meaning that there are N data points. The feature list of modern data contains the feature list of the mechanistic model. There is an unknown relationship between xⁱ and yⁱ.

Constraints on the prediction may be imposed by experts with infinitely many parameters in a closed range.

The general formulation of the problem may take the form

$$solve {min}_{w} {\sum }_{i = 1}^{N} {( {f}^{i} ( w ) - {y}^{i} )}^{2} + {μ ( {f}^{i} ( w ) - {g}^{i} )}^{2} \qquad ( 4 )$$

while satisfying (i.e., subject to)

f^{x}(w)≤c₁, ∀x∈X (5)

f^{x}(w)≤c₃, ∀x∈X∩H (6)

The quantity μ is a positive number that assigns the weight to the mechanism model.

Two prediction models are discussed with respect to embodiments: a linear prediction model and a quadratic prediction model.

For the linear prediction model, fⁱ(w) is set to

fⁱ(w)=w^{T}xⁱ+w₀, f^{x}(w)=w^{T}x+w₀ (7)

The objective function is written as:

Σᵢ₌₁^{N}(w^{T}xⁱ+w₀−yⁱ)²+μ(w^{T}xⁱ+w₀−gⁱ)² (8)

with the following constraints:

Type 1: w^{T}x+w₀≤c+β^{T}x, ∀x∈X (9)

Type 2: w^{T}x+w₀≤c, ∀x∈X∩H (10)

For the quadratic prediction model, fⁱ(γ,q,Q) is set to:

fⁱ(γ,q,Q)=γ+2q^{T}xⁱ+(xⁱ)^{T}Qxⁱ, f^{x}(γ,q,Q)=γ+2q^{T}x+(x)^{T}Qx (11)

The isometric realization:

$${x}^{T} Qx + 2 {q}^{T} x + γ = 〈 [ \begin{matrix}γ & {q}^{T} \\ q & Q\end{matrix} ] , [ \begin{matrix}1 & {x}^{T} \\ x & x {x}^{T}\end{matrix} ] 〉 = 〈 W , {Y}_{x} 〉 = 〈 \tilde{w} , \tilde{x} 〉 , \qquad ( 12 )$$

where

\tilde{w}=svec(W), \tilde{x}=svec(Yₓ) (13)

This is described herein.

The objective function can be written as:

Σᵢ₌₁^{N}( [symbol] \tilde{w},\tilde{x}ⁱ [symbol] −yⁱ)²+μ( [symbol] \tilde{w},\tilde{x}ⁱ [symbol] −gⁱ)² (14)

and the constraints as:

Type 1: [symbol] \tilde{w},\tilde{x} [symbol] ≤c₁+β^{T}x, ∀x∈X (15)

Type 2: [symbol] \tilde{w},\tilde{x} [symbol] ≤c₃, ∀x∈X∩H (16)

Modern computers with standard software cannot accommodate mathematical models with infinitely many constraints. The prediction model reformulation framework handles such difficulties effectively by utilizing duality theory. In particular, it uses the duality theory to convert the problem with infinitely many constraints with a finite number of variables and a finite number of constraints. As a consequence, the prediction model reformulation framework converts the intractable model into a quadratic program that is efficiently solvable in theory and practice.

The prediction model reformulation framework described herein amy be applicable to scenarios when the exact model parameters are unknown but they lie in a certain range. For example, it can be used where a decision maker wishes to build a prediction function where the predicted value must be less than equal to a given value. Moreover, the predicted value generated by the prediction function must be less than equal to a given value for all realization of the uncertain model parameters.

In order to illustrate the approach described herein, it will now be discussed with respect to a real-life example. An owner of an all-you-can-eat (AYCE) sushi restaurant wants to expand the menu with Chinese cuisine. The owner, by his/her expertise, knows the cost of ingredients that each customer consumes. The decision maker needs some reference data to evaluate different Chinese entrees, and there is a set of available data collected by Chinese restaurant community. As the decision maker runs an AYCE restaurant, customers do not consume an exact set amount of ingredients. For example, each diner consumes a different amount of rice, from 0 g to 50 g. Hence, uncertain model parameters appear in this model.

Uncertainty arises in many real-life situations. The proposed approach helps the user adapt to the unpredictable future.

Modern computers cannot accommodate mathematical models with infinitely many constraints. The proposed approach may handle such difficulties effectively.

The linear and quadratic prediction models generated by the prediction model reformulation framework can be solved using any quadratic programming (QP) solvers; i.e., they are efficiently solvable.

### Linear Prediction Model

In a first embodiment, the manner by which how the prediction model reformulation framework converts the intractable from into a tractable form for the linear prediction model will now be described.

The data (xⁱ, yⁱ) and the mechanism model gⁱ:=g(xⁱ)=g^{T}xⁱ+g₀ are given. They are described previously herein.

The linear prediction, fⁱ(w), is:

fⁱ(w)=w^{T}xⁱ+w₀, f^{x}(w)=w^{T}x+w₀ (17)

The term w₀ represents the bias of the prediction.

Let A be the matrix such that each row of A is [1;(xⁱ)^{T}], ŷ be a vector of N entries where the i-th element is yⁱ, and ĝ be a vector of N entries where the i-th element is gⁱ. The objective function can be rewritten in the form:

$${\sum }_{i = 1}^{N} {( {w}^{T} {x}^{i} + {w}_{0} - {y}^{i} )}^{2} + {μ ( {w}^{T} {x}^{i} + {w}_{0} - {g}^{i} )}^{2} = {‖ A [ {w}_{0} ; w ] - \hat{y} ‖}^{2} + μ {‖ A [ {w}_{0} ; w ] - \hat{g} ‖}^{2} , \qquad ( 18 )$$

which can be rewritten as:

(1+μ)[w₀;w]^{T}A^{T}A[w₀;w]+2 [symbol] A^{T}(ŷ+μĝ),[w₀;w] [symbol] +∥ŷ∥²+μ∥ĝ∥² (19)

The objective function is now in the form of a conventional convex quadratic function.

The Type 1 constraint is written as:

w^{T}x+w₀≤c₁+β^{T}x, ∀x∈X (20)

Here, the decision maker provides the following parameters that suits their own purpose:

β is a vector, (21)

c₁ is a constant (a number), and (22)

X is a hypercube of the form X={x∈Rⁿ:lᵢ≤xᵢ≤uᵢ, ∀i=1, . . . , n} and lᵢ<uᵢ (23)

The following equivalence is obtained; i.e., equation (24) is equivalent to equation (25):

$$\begin{matrix}{w}^{T} x + {w}_{0} \leq {c}_{1} + {β}^{T} x , ∀ x ∈ X & ( 24 ) \\ {max}_{x ∈ X} \{ {w}^{T} x - {β}^{T} x \} \leq {c}_{1} - {w}_{0} & ( 25 )\end{matrix}$$

It is noted that:

$${max}_{x ∈ X} \{ {w}^{T} x - {β}^{T} x \} = {max}_{x} \{ 〈 w - β , x 〉 : l \leq x \leq u \} . \qquad ( 26 )$$

By the duality theory,

$${max}_{x} \{ 〈 w - β , x 〉 : l \leq x \leq u \} = {min}_{v} \{ 〈 u - l , v 〉 + 〈 l , w - β 〉 : v - w + β \geq 0 , v \geq 0 \} . \qquad ( 27 )$$

Thus, equation (24) is equivalent to equation (28):

w₀+ [symbol] u−l,v [symbol] + [symbol] l,w−β [symbol] ≤c₁,v−w+β≥0,v≥0 (28)

The inequalities in equation (28) have the variables w,v, whereas equation (24) has the single variable w. It is noted that an additional variable v was introduced in equation (28) in order to handle the infinitely many model parameters.

Equation (28) is used in order to obtain a tractable model.

The type 2 constraint can be written as:

w^{T}x≤c₃, ∀x∈X∩H (29)

Here, the decision maker provides the following parameters that suit their own purpose.

c₃ is a constant (a number), (30)

X is a hypercube of the form given in constraint type 1, and (31)

H is a halfspace of the form H={x∈Rⁿ: [symbol] d,x [symbol] ≤c₄}, d≥0 (32)

A similar approach introduced in constraint type 1 above is used. The following equivalence is obtained; i.e., equation (33) is equivalent to equation (34):

w^{T}x+w₀≤c₄, ∀x∈X∩H (33)

$${max}_{x ∈ X ⋂ H} \{ {w}^{T} x \} \leq {c}_{4} - {w}_{0} \qquad ( 34 )$$

By the duality theory, it is observed that:

$${max}_{x ∈ X ⋂ H} \{ {w}^{T} x \} = {max}_{x} \{ {w}^{T} x : 〈 d , x 〉 \leq {c}_{4} ; l \leq x \leq u \} = {min}_{v} \{ 〈 u - l , v 〉 + λ ( {c}_{4} - {d}^{T} l ) + 〈 l , w 〉 : [ I d ] [ v ; λ ] \geq w , v \geq 0 , λ \geq 0 \} . \qquad ( 35 )$$

Thus, equation (33) is equivalent to equation (36):

w₀+ [symbol] u−l,v [symbol] +λ(c₄−d^{T}l)+ [symbol] l,w [symbol] ≤c₃, [I d][v;λ]≥w, v≥0, λ≥0 (36)

The inequalities in equation (36) have the variables w, v, λ, whereas equation (33) has the single variable w. It is noted that the additional variable v was introduced in order to handle the parameters in X. The additional variable λ is introduced to capture the parameters associated with H.

Equation (36) is used in order to obtain a tractable model.

The final tractable reformulated model is as follows:

$${{min}_{{w}_{0} , w , {v}_{1} , {v}_{2}} ( 1 + μ ) [ {w}_{0} ; w ]}^{T} {A}^{T} A [ {w}_{0} ; w ] + 2 〈 {A}^{T} ( \hat{y} + μ \hat{g} ) , [ {w}_{0} , w ] 〉 + {‖ \hat{y} ‖}^{2} + μ {‖ \hat{g} ‖}^{2} \qquad ( 37 )$$

subject to:

w₀+ [symbol] u−1,v₁ [symbol] + [symbol] l,w−β [symbol] ≤c₁ (38)

v₁−w+β≥0 (39)

v₁≥0 (40)

w₀+ [symbol] u−l,v₂ [symbol] +λ(c₄−d^{T}l)+ [symbol] l,w [symbol] ≤c₃ (41)

[I d][v₂;λ]≥w, (42)

v₂≥0, and (43)

λ≥0 (44)

The reformulated model is now a conventional convex quadratic program and a standard QP solver can be used to find a solution. Of note is that, for each constraint, an individual variable v must be introduced. In the above model, v₁,v₂ are responsible for the individual v that appear in the derivation of the constraints. Once the model is solved, set the prediction function as

prediction(x)=w^{T}x+w₀ (45)

### Quadratic Prediction Model

In another embodiment, it is elaborated how the prediction model reformulation framework converts the intractable form into a tractable form for the quadratic prediction model.

The data (xⁱ,yⁱ) and the mechanism model gⁱ:=g(xⁱ)=g^{T}xⁱ+g₀ is given. They are described herein above and they are the same data used in the previously described linear equation embodiment.

The quadratic prediction can be written as:

fⁱ(γ,q,Q)=γ+2q^{T}xⁱ+(xⁱ)^{T}Qxⁱ, f^{x}(γ,q,Q)=γ+2q^{T}x+(x)^{T}Qx (46)

The term γ is responsible for the bias of the prediction.

The general conversion scheme used for the quadratic prediction model is the same as the one in the linear model. However, before adopting the theory described with reference to the linear equation embodiment above, a sophisticated transformation is performed. That is, a mathematical conversion is performed that allows for the interpretation of the quadratic form as a linear form.

First, a function, svec(.), is defined. The term Sⁿ is used to denote the vector space of n-by-n symmetric matrices. Then,

svec:Sⁿ→R^{n(n+1)/2} by svec(M)=[diagonal of M; √2̅ strict upper triangular part of M]. (47)

The svec(.) operation appears in numerous literature reference, such as “On the Kronecker Product”, Kathrin Schäcke, Aug. 1, 2013. The svec(.) mapping is often used to carry the minimum number of variables in mathematical operations. By using svec(.), the inner product in Sⁿ as the inner product in R^{n(n+1)/2} can be realized as follows:

[symbol]

M₁,M₂ [symbol] = [symbol] svec(M₁), svec(M₂) [symbol] = [symbol] \tilde{m}₁,\tilde{m}₂ [symbol] , where (48)

M₁,M₂∈Sⁿ (49)

\tilde{m}₁=svec(M₁), and (50)

\tilde{m}₂=svec(M₂) (51)

Additionally, a function is defined that discards the first entry of svec(.):

$${svec}_{0} : {S}^{n} \to {R}^{\frac{n ( n + 1 )}{2} - 1} by {svec}_{0} ( M ) = svec ( M ) [ 2 : \frac{n ( n + 1 )}{2} ] . \qquad ( 52 )$$

Let Ã be the matrix that each row of Ã is [1,(svec(xⁱ))^{T}], ŷ be a vector of N entries where i-th element is yⁱ, and ĝ be a vector of N entries where i-th element is gⁱ. Then the objective function is of the form

$${\sum }_{i = 1}^{N} {( 〈 svec ( \tilde{W} ) , svec ( {Y}_{{x}^{i}} ) 〉 - {y}^{i} )}^{2} + {μ ( 〈 svec ( \tilde{W} ) , svec ( {Y}_{{x}^{i}} ) 〉 - {g}^{i} )}^{2} \qquad ( 53 )$$

$$where$$

$$\begin{matrix}\tilde{W} = [ \begin{matrix}γ & {q}^{T} \\ q & Q\end{matrix} ] , & ( 54 ) \\ \tilde{w} = svec ( \tilde{W} ) , and & ( 55 ) \\ {Y}_{{x}^{i}} = [ \begin{matrix}1 & {( {x}^{i} )}^{T} \\ {x}^{i} & {{x}^{i} ( {x}^{i} )}^{T}\end{matrix} ] . & ( 56 )\end{matrix}$$

Then the objective function can be rewritten as

(1+μ)svec(\tilde{W})^{T}Ã^{T}Ãsvec(\tilde{W})+2 [symbol] Ã^{T}(ŷ+μĝ),svec(\tilde{W}) [symbol] +∥ŷ∥²+μ∥ĝ∥² (57)

The objective function is a conventional quadratic function.

The type 1 constraint is in the form:

γ+2q^{T}x+(x)^{T}Qx≤c₁+β^{T}x, ∀x∈X (58)

Here, the decision maker must provide the following parameters that suits their own purpose: β, c₁, and X. They are identical to the ones described herein above.

The svec(.) operation is applied:

$$γ + 2 {q}^{T} x + {x}^{T} Qx = 〈 [ \begin{matrix}γ & {q}^{T} \\ q & Q\end{matrix} ] , [ \begin{matrix}1 & {x}^{T} \\ x & {xx}^{T}\end{matrix} ] 〉 = 〈 svec ( \tilde{W} ) , svec ( {Y}_{x} ) 〉 , where {Y}_{x} = [ \begin{matrix}1 & {x}^{T} \\ x & {xx}^{T}\end{matrix} ] . \qquad ( 59 )$$

Then the type 1 constraint has the following representation:

[symbol]

svec(\tilde{W}),svec(Yₓ) [symbol] +c₁+β^{T}x, ∀x∈X (60)

We represent equation (60) as

$${max}_{{svec}^{- 1} ( y ) ∈ conv ( \{ {Y}_{x} : x ∈ X \} )} \{ {svec ( \tilde{W} )}^{T} y - 〈 svec ( [ \begin{matrix}0 & 0.5 {β}^{T} \\ 0.5 β & 0\end{matrix} ] ) , y 〉 \} \leq {c}_{1} . \qquad ( 61 )$$

The two sets Y̅, \tilde{Y}, the lifted cube and the set after the isoemtric realization are defined, respectively, as follows:

$$\begin{matrix}\overline{Y} = \{ Y ∈ {S}^{n + 1} : {:}_{i , j} \leq {Y}_{i , j} \leq {U}_{i , j} , ∀ i , j \} , where L = [ \begin{matrix}1 & {l}^{T} \\ l & {ll}^{T}\end{matrix} ] , U = [ \begin{matrix}1 & {u}^{T} \\ u & {uu}^{T}\end{matrix} ] , & ( 62.1 ) \\ \tilde{Y} = \{ y ∈ {R}^{\frac{( n + 1 ) ( n + 2 )}{2} - 1} : \tilde{l} \leq y \leq \tilde{u} \} , where \tilde{l} = {svec}_{0} ( L ) , \tilde{u} = {svec}_{0} ( U ) . & ( 62.2 )\end{matrix}$$

We note the containment relation:

conv({Yₓ:x∈X})⊆Y̅, (62.3)

where cony denotes the convex hull. Since the geometry of conv({Yₓ:x∈X}) is complex, the set conv({Yₓ:x∈X}) is replaced with Y̅. Equation (61) can be reformulated using this approximation as

$${max}_{{svec}^{- 1} ( y ) ∈ \tilde{Y}} \{ {svec ( \tilde{W} )}^{T} y - 〈 svec ( [ \begin{matrix}0 & 0.5 {β}^{T} \\ 0.5 β & 0\end{matrix} ] ) , y 〉 \} \leq {c}_{1} . \qquad ( 63 )$$

It is noted that equation (63) is a linear program. Thus, the same operation performed herein above can be applied. Then, equation (63) can be replace with the inequalities listed in equation (64) below:

$$\begin{matrix}{\tilde{w}}_{0} + 〈 \tilde{l} , \tilde{w} 〉 + 〈 \tilde{u} - \tilde{l} , \tilde{s} 〉 \leq {c}_{1} - 〈 \tilde{l} , {svec}_{0} ( [ \begin{matrix}0 & 0.5 {β}^{T} \\ 0.5 β & 0\end{matrix} ] ) 〉 , & ( 64 ) \\ - \tilde{w} + \tilde{s} - {svec}_{0} ( [ \begin{matrix}0 & 0.5 {β}^{T} \\ 0.5 β & 0\end{matrix} ] ) \geq 0 , and & ( 65 ) \\ \tilde{s} \geq 0. & ( 66 )\end{matrix}$$

In equations (64) to (66), the variable dimensions are:

$${\tilde{w}}_{0} ∈ R , \tilde{w} ∈ {R}^{\frac{( n + 1 ) ( n + 2 )}{2} - 1} , \tilde{s} ∈ {R}_{+}^{\frac{( n + 1 ) ( n + 2 )}{2} - 1} . \qquad ( 67 )$$

The type 2 constraint is written as:

γ+2q^{T}x+x^{T}Qx≤c₃, ∀x∈X∩H (68)

The decision maker provides the following parameters c₃,X,H (described above) that suit the decision maker's own purpose.

For the type 2 constraint for the quadratic prediction model, an approximation of the set intersection X∩H may be performed. This is due to the NP-hardness of the general nonconvex quadratic programs. In approximating the intersection xnH, a decision by the decision maker has to be involved.

A scheme is provided for approximating the set X∩H using two hypercubes. That is, the desire is to obtain two sets:

B₁⊆X∩H⊆B₂, (69)

where B₁, B₂ are hypercubes.

A hypercube B₂ that contains X∩H may be obtained as below:

B₂={x∈Rⁿ:l̅≤x≤ū} (70)

where:

$${\overline{l}}_{i} = {min}_{x} \{ {x}_{i} : x ∈ X ∩ H \} , ∀ i , \qquad ( 71 )$$

$${\overline{u}}_{i} = {max}_{x} \{ {x}_{i} : x ∈ X ∩ H \} , ∀ i . \qquad ( 72 )$$

It is now desired to obtain a hypercube B₁ that is contained in X∩H:

[symbol]

d,x [symbol] ≤c₄ is eqivalent to Σ_{i:d}_{ᵢ}_{>0}dᵢxᵢ23 c₄ (73)

Let ĉ be a number that holds:

ĉ=Σ_{i:d}_{ᵢ}_{>0}cᵢ, (74)

for some cᵢ's. For each i such that dᵢ>0, a halfspace

$$〈 {e}_{i} , x 〉 \leq \frac{{c}_{i}}{{d}_{i}} \qquad ( 75 )$$

is generated, where eᵢ is the i-th column of the identity matrix. Then, by setting B₁ as below,

$${B}_{1} = X ∩ \{ x : {x}_{i} \leq \frac{{c}_{i}}{{d}_{i}} , for i such that {d}_{i} > 0 \} , \qquad ( 76 )$$

B₁ that is contained in X∩H is obtained.

B₂ is chosen for an approximation and replaces X∩H. A similar approach introduced for constraint type 1 and the type 2 constraint above.

Let

$$\hat{l} = {svec}_{0} ( [ \begin{matrix}1 & {\overline{l}}^{T} \\ \overline{l} & \overline{l} {\overline{l}}^{T}\end{matrix} ] ) , and \qquad ( 77 )$$

$$û = {svec}_{0} ( [ \begin{matrix}1 & {\overline{u}}^{T} \\ \overline{u} & \overline{u} {\overline{u}}^{T}\end{matrix} ] ) . \qquad ( 78 )$$

The inequalities below are used to replace the type 2 constraint for the quadratic prediction model.

\tilde{w}₀+ [symbol] \hat{l},\tilde{w} [symbol] + [symbol] û−\hat{l},\tilde{s} [symbol] ≤c₃ (79)

−\tilde{w}+\tilde{s}≥0, and (80)

\tilde{s}≥0 (81)

The variable dimensions are

$${\tilde{w}}_{0} ∈ R , \qquad ( 82 )$$

$$\tilde{w} ∈ {R}^{\frac{( n + 1 ) ( n + 2 )}{2} - 1} , and \qquad ( 83 )$$

$$\tilde{s} ∈ {{R}_{+}}^{\frac{( n + 1 ) ( n + 2 )}{2} - 1} . \qquad ( 84 )$$

The final tractable reformulated model is as follows:

$${{min}_{{\tilde{w}}_{0} {\tilde{, w}}_{0} , {\tilde{s}}_{1} , {\tilde{s}}_{2}} ( 1 + μ ) [ {\tilde{w}}_{0} ; \tilde{w} ]}^{T} {Ã}^{T} Ã [ {\tilde{w}}_{0} ; \tilde{w} ] + 2 〈 {Ã}^{T} ( \hat{y} + μ \hat{g} ) , [ {\tilde{w}}_{0} ; \tilde{w} ] 〉 + {‖ \hat{y} ‖}^{2} + μ {‖ \hat{g} ‖}^{2} \qquad ( 85 )$$

subject to

$${\tilde{w}}_{0} + 〈 \tilde{l} , \tilde{w} 〉 + 〈 \tilde{u} - \tilde{l} , {\tilde{s}}_{1} 〉 \leq {c}_{1} - 〈 \tilde{l} , {svec}_{0} ( [ \begin{matrix}0 & 0.5 {β}^{T} \\ 0.5 β & 0\end{matrix} ] ) 〉 , \qquad ( 86 )$$

$$- \tilde{w} + {\tilde{s}}_{1} - {svec}_{0} ( [ \begin{matrix}0 & 0.5 {β}^{T} \\ 0.5 β & 0\end{matrix} ] ) \geq 0 , {\tilde{s}}_{1} \geq 0 , \qquad ( 86 )$$

$${\tilde{w}}_{0} + 〈 \tilde{l} , \tilde{w} 〉 + 〈 \tilde{u} - \tilde{l} , {\tilde{s}}_{2} 〉 \leq {c}_{3} , \qquad ( 87 )$$

$$- \tilde{w} + {\tilde{s}}_{2} \geq 0 , and \qquad ( 88 )$$

$${\tilde{s}}_{2} \geq 0. \qquad ( 89 )$$

Of note is that for each constraint, individual variable \tilde{s} must be introduced, as discussed herein above. Once the model is solved, the original form is recovered by taking the inverse of the svec(.) mapping:

W*=svec⁻¹([\tilde{w}₀;\tilde{w}]) (90)

The following assignment is made:

$$[ \begin{matrix}γ & {q}^{T} \\ q & Q\end{matrix} ] = {W}^{*} , \qquad ( 91 )$$

and the prediction function is set as

prediction(x)=γ+2q^{T}x+(x)^{T}Qx (92)

An alternative approximation for the set conv({Yₓ:x∈X}) is now provided. It is noted that the containment relation is:

conv({Yₓ:x∈X})⊆Y̅∩S₊ⁿ⁺¹⊆Y̅ (93)

Equation (63) in the type 1 constraint can be replaced by

$${max}_{s v e {c}^{- 1} ( y ) ∈ \overline{Y} ∩ {S}_{+}^{n + 1}} \{ {svec ( \tilde{W} )}^{T} y - 〈 svec ( [ \begin{matrix}0 & 0.5 {β}^{T} \\ 0.5 β & 0\end{matrix} ] ) , y 〉 \} \leq {c}_{1} . \qquad ( 94 )$$

That is, Y̅ is replaced by Y̅∩S₊ⁿ⁺¹. The duality theory can be employed to reformulate this model. This approximation yields the reformulated model to lie in the class of the semidefinite programs. There are semidefinite programming solvers available.

The approaches described above may provide an efficient and effective reformulation framework for addressing problems with infinitely many model parameters that are not conventionally solvable via standard software. The prediction made by every realized data point from the uncertain range satisfies the required upper bound. The disclosed prediction model reformulation framework may convert an intractable model to a tractable model. The tractable model does not require a specific solver. Any QP solver available in the market can be used.

Two models, linear and quadratic, are proposed herein above under the assumption that the lower and upper bounds of the uncertain bounds do not agree; i.e., lᵢ<uᵢ. If there are features that hold lᵢ=uᵢ, higher order models may be applied to in conjunction with the model proposed. That is, for the features that hold lᵢ<uᵢ, the proposed method may also be applied, and for the features that hold lᵢ=uᵢ, any arbitrary prediction function can be applied. The logistic function is an example and appears in many disciplines of machine learning.

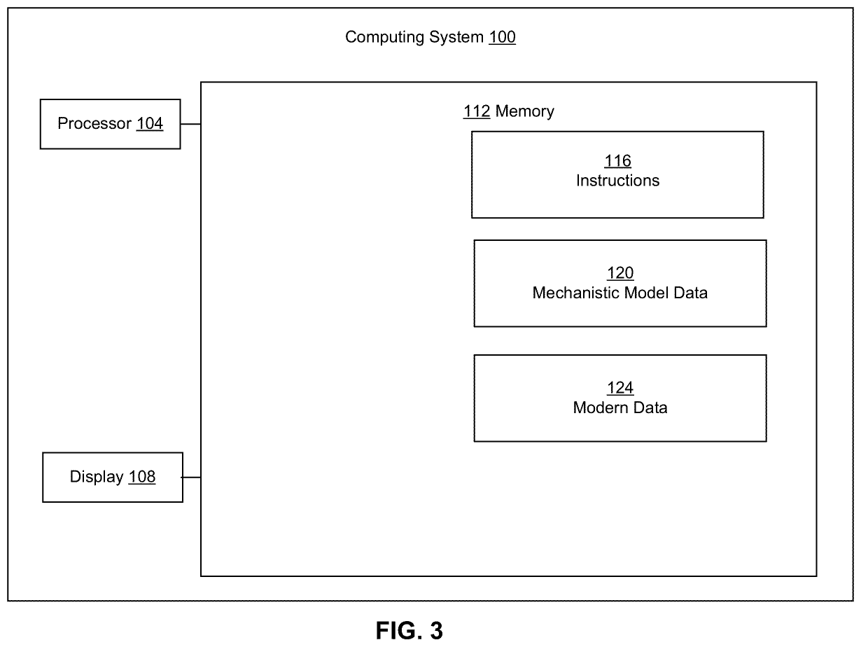

FIG. 3 shows various physical and logical components of an exemplary computing system 100 for formulating a prediction model and for using a formulated prediction model in accordance with an embodiment of the present disclosure. Although an example embodiment of the computing system 100 is shown and discussed below, other embodiments may be used to implement examples disclosed herein, which may include components different from those shown. Although FIG. 3 shows a single instance of each component of the computing system 100, there may be multiple instances of each component shown.

The computing system 100 includes one or more processors 104, such as a central processing unit, a microprocessor, an application-specific integrated circuit (ASIC), a field-programmable gate array (FPGA), a dedicated logic circuitry, a tensor processing unit, a neural processing unit, a dedicated artificial intelligence processing unit, or combinations thereof. The one or more processors 104 may collectively be referred to as a processor 104. The computing system 100 may include a display 108 for outputting data and/or information in some applications, but may not in some other applications.

The computing system 100 includes one or more memories 112 (collectively referred to as “memory 112”), which may include a volatile or non-volatile memory (e.g., a flash memory, a random access memory (RAM), and/or a read-only memory (ROM)). The non-transitory memory 112 may store machine-executable instructions for execution by the processor 104. A set of machine-executable instructions 116 defining a prediction model formulation process (described herein) and a process for using the formulated prediction model is shown stored in the memory 112, which may be executed by the processor 104 to perform the steps of the methods for reformulating a prediction model and for using the same described herein. The memory 112 may include other machine-executable instructions for execution by the processor 104, such as machine-executable instructions for implementing an operating system and other applications or functions.

The memory 112 stores mechanistic model data 120 and modern data 124 as described herein.

The memory 108 may also store other data, information, rules, policies, and machine-executable instructions described herein.

In some examples, the computing system 100 may also include one or more electronic storage units (not shown), such as a solid state drive, a hard disk drive, a magnetic disk drive and/or an optical disk drive. In some examples, one or more datasets and/or modules may be provided by an external memory (e.g., an external drive in wired or wireless communication with the computing system 100) or may be provided by a transitory or non-transitory computer-executable medium. Examples of non-transitory computer readable media include a RAM, a ROM, an erasable programmable ROM (EPROM), an electrically erasable programmable ROM (EEPROM), a flash memory, a CD-ROM, or other portable memory storage. The storage units and/or external memory may be used in conjunction with memory 112 to implement data storage, retrieval, and caching functions of the computing system 100.

The components of the computing system 100 may communicate with each other via a bus, for example. In some embodiments, the computing system 100 is a distributed computing system and may include multiple computing devices in communication with each other over a network, as well as optionally one or more additional components. The various operations described herein may be performed by different computing devices of a distributed system in some embodiments. In some embodiments, the computing system 100 is a virtual machine provided by a cloud computing platform.

Although the components for both formulating a prediction model and for using the same are shown as part of the computing system 100, it will be understood that separate computing devices can be used for formulating a prediction model and for using the same.

### General

Through the descriptions of the preceding embodiments, the present invention may be implemented by using hardware only, or by using software and a necessary universal hardware platform, or by a combination of hardware and software. The coding of software for carrying out the above-described methods described is within the scope of a person of ordinary skill in the art having regard to the present disclosure. Based on such understandings, the technical solution of the present invention may be embodied in the form of a software product. The software product may be stored in a non-volatile or non-transitory storage medium, which can be an optical storage medium, flash drive or hard disk. The software product includes a number of instructions that enable a computing device (personal computer, server, or network device) to execute the methods provided in the embodiments of the present disclosure.

All values and sub-ranges within disclosed ranges are also disclosed. Also, although the systems, devices and processes disclosed and shown herein may comprise a specific plurality of elements, the systems, devices and assemblies may be modified to comprise additional or fewer of such elements. Although several example embodiments are described herein, modifications, adaptations, and other implementations are possible. For example, substitutions, additions, or modifications may be made to the elements illustrated in the drawings, and the example methods described herein may be modified by substituting, reordering, or adding steps to the disclosed methods.

Features from one or more of the above-described embodiments may be selected to create alternate embodiments comprised of a sub-combination of features which may not be explicitly described above. In addition, features from one or more of the above-described embodiments may be selected and combined to create alternate embodiments comprised of a combination of features which may not be explicitly described above. Features suitable for such combinations and sub-combinations would be readily apparent to persons skilled in the art upon review of the present disclosure as a whole.

In addition, numerous specific details are set forth to provide a thorough understanding of the example embodiments described herein. It will, however, be understood by those of ordinary skill in the art that the example embodiments described herein may be practiced without these specific details. Furthermore, well-known methods, procedures, and elements have not been described in detail so as not to obscure the example embodiments described herein. The subject matter described herein and in the recited claims intends to cover and embrace all suitable changes in technology.

Although the present invention and its advantages have been described in detail, it should be understood that various changes, substitutions and alterations can be made herein without departing from the invention as defined by the appended claims.

The present invention may be embodied in other specific forms without departing from the subject matter of the claims. The described example embodiments are to be considered in all respects as being only illustrative and not restrictive. The present disclosure intends to cover and embrace all suitable changes in technology. The scope of the present disclosure is, therefore, described by the appended claims rather than by the foregoing description. The scope of the claims should not be limited by the embodiments set forth in the examples, but should be given the broadest interpretation consistent with the description as a whole.

1. A computing system for formulating a prediction model, comprising:
one or more processors;
a memory storing computer-executable instructions that, when executed 5 by the one or more processors, cause the computing system to:
receive a linear prediction of an expert model wherein given point xⁱ, the linear prediction is gⁱ:=g(xⁱ)=g^{T}xⁱ+g₀, the expert model having an expert model feature list;
receive new data (xⁱ, yⁱ) ∀i∈[1, N], wherein the expert model feature list is a subset of a new feature list of the new data; and
formulate a prediction model as:
$${min}_{w} {\sum }_{i = 1}^{N} {( {f}^{i} ( w ) - {y}^{i} )}^{2} + {μ ( {f}^{i} ( w ) - {g}^{i} )}^{2} ,$$
wherein:
f^{x}(w)≤c₁, ∀x∈X, and
f^{x}(w)≤c₃, ∀x∈X∩H, and
wherein μ is a positive number assigning weight to the linear prediction.

2. The computing system of claim 1, wherein the computer-executable instructions, when executed by the one or more processors, cause the computing system to formulate the prediction model as a linear prediction model, fⁱ(w), set to:
fⁱ(w)=w^{T}xⁱ+w₀, f^{x}(w)=w^{T}x+w₀
with an objective function of:
Σᵢ₌₁^{N}(w^{T}xⁱ+w₀−yⁱ)²+μ(w^{T}xⁱ+w₀−gⁱ)², and
with the following constraints:
type 1: w^{T}x+w₀≤c+β^{T}x, ∀x∈X, and
type 2: w^{T}x+w₀≤c, ∀x∈X∩H

3. The computing system of claim 1, wherein the computer-executable instructions, when executed by the one or more processors, cause the computing system to formulate the prediction model as a quadratic prediction model, fⁱ(γ,q,Q), set to:
fⁱ(γ,q,Q)=γ+2q^{T}xⁱ+(xⁱ)^{T}Qxⁱ, f^{x}(γ,q,Q)=γ+2q^{T}x+(x)^{T}Qx
with an isometric realization
$${x}^{T} Q x + 2 {q}^{T} x + γ = 〈 [ \begin{matrix}γ & {q}^{T} \\ q & Q\end{matrix} ] , [ \begin{matrix}1 & {x}^{T} \\ x & x {x}^{T}\end{matrix} ] 〉 = 〈 W , {Y}_{x} 〉 = 〈 \tilde{w} , \tilde{x} 〉 ,$$
wherein
\tilde{w}=svec(W), \tilde{x}=svec(Yₓ),
wherein an objective function can be written as:
Σᵢ₌₁^{N}( [symbol] \tilde{w},\tilde{x}ⁱ [symbol] −yⁱ)²+μ( [symbol] \tilde{w},\tilde{x}ⁱ [symbol] −gⁱ)², and
wherein the constraints can be written as:
type 1: [symbol] \tilde{w},\tilde{x} [symbol] ≤c₁+β^{T}x, ∀x∈X, and
type 2: [symbol] \tilde{w},\tilde{x} [symbol] ≤c₃, ∀x∈X∩H.

4. A computer-implemented method for formulating a prediction model, comprising:
receiving a linear prediction of an expert model wherein given point xⁱ, the linear prediction is gⁱ:=g(xⁱ)=g^{T}xⁱ+g₀, the expert model having an expert model feature list;
receiving new data (xⁱ,yⁱ)∀i∈[1,N], wherein the expert model feature list is a subset of a new feature list of the new data; and
formulating a prediction model as:
$${min}_{w} {\sum }_{i = 1}^{N} {( {f}^{i} ( w ) - {y}^{i} )}^{2} + {μ ( {f}^{i} ( w ) - {g}^{i} )}^{2} ,$$
wherein:
f^{x}(w)≤c₁, ∀x∈X, and
f^{x}(w)≤c₃, ∀x∈X∩H, and
wherein μ is a positive number assigning weight to the linear prediction.

5. The method of claim 4, wherein the prediction model as formulated as a linear prediction model, fⁱ(w), set to:
fⁱ(w)=w^{T}xⁱ+w₀, f^{x}(w)=w^{T}x+w₀
with an objective function of:
Σᵢ₌₁^{N}(w^{T}xⁱ+w₀−yⁱ)²+μ(w^{T}xⁱ+w₀−gⁱ)², and
with the following constraints:
type 1: w^{T}x+w₀≤c+β^{T}x, ∀x∈X, and
type 2: w^{T}x+w₀≤c, ∀x∈X∩H.

6. The method of claim 4, wherein the prediction model is formulated as a quadratic prediction model, fⁱ(γ,q,Q), set to:
fⁱ(γ,q,Q)=γ+2q^{T}xⁱ+(xⁱ)^{T}Qxⁱ, f^{x}(γ,q,Q)=γ+2q^{T}x+(x)^{T}Qx
with an isometric realization
$${x}^{T} Q x + 2 {q}^{T} x + γ = 〈 [ \begin{matrix}γ & {q}^{T} \\ q & Q\end{matrix} ] , [ \begin{matrix}1 & {x}^{T} \\ x & x {x}^{T}\end{matrix} ] 〉 = 〈 W , {Y}_{x} 〉 = 〈 \tilde{w} , \tilde{x} 〉 ,$$
wherein
\tilde{w}=svec(W), \tilde{x}=svec(Yₓ),
wherein an objective function can be written as:
Σᵢ₌₁^{N}( [symbol] \tilde{w},\tilde{x}ⁱ [symbol] −yⁱ)²+μ( [symbol] \tilde{w},\tilde{x}ⁱ [symbol] −gⁱ)², and
wherein the constraints can be written as:
type 1: [symbol] \tilde{w},\tilde{x} [symbol] ≤c₁+β^{T}x, ∀x∈X, and
type 2: [symbol] \tilde{w},\tilde{x} [symbol] ≤c₃, ∀x∈X∩H.

7. A non-transitory machine-readable medium having tangibly stored thereon computer-executable instructions for execution by one or more processors, wherein the computer-executable instructions, in response to execution by the one or more processors, cause the one or more processors to:
receive a linear prediction of an expert model wherein given point xⁱ, the linear prediction is gⁱ:=g(xⁱ)=g^{T}xⁱ+g₀, the expert model having an expert model feature list;
receive new data (xⁱ,yⁱ)∀i∈[1,N], wherein the expert model feature list is a subset of a new feature list of the new data; and
formulate a prediction model as:
$${min}_{w} {\sum }_{i = 1}^{N} {( {f}^{i} ( w ) - {y}^{i} )}^{2} + {μ ( {f}^{i} ( w ) - {g}^{i} )}^{2} ,$$
wherein:
f^{x}(w)≤c₁, ∀x∈X, and
f^{x}(w)≤c₃, ∀x∈X∩H, and
wherein μ is a positive number assigning weight to the linear prediction.

8. The non-transitory machine-readable medium of claim 7, wherein the computer-executable instructions, when executed by the one or more processors, cause the computing system to formulate the prediction model as a linear prediction model, fⁱ(w), set to:
fⁱ(w)=w^{T}xⁱ+w₀, f^{x}(w)=w^{T}x+w₀
with an objective function of:
Σᵢ₌₁^{N}(w^{T}xⁱ+w₀−yⁱ)²+μ(w^{T}xⁱ+w₀−gⁱ)², and
with the following constraints:
type 1: w^{T}x+w₀≤c+β^{T}x, ∀x∈X, and
type 2: w^{T}x+w₀≤c, ∀x∈X∩H

9. The non-transitory machine-readable medium of claim 7, wherein the computer-executable instructions, when executed by the one or more processors, cause the computing system to formulate the prediction model as a quadratic prediction model, fⁱ(γ,q,Q), set to:
fⁱ(γ,q,Q)=γ+2q^{T}xⁱ+(xⁱ)^{T}Qxⁱ, f^{x}(γ,q,Q)=γ+2q^{T}x+(x)^{T}Qx
with an isometric realization
$${x}^{T} Q x + 2 {q}^{T} x + γ = 〈 [ \begin{matrix}γ & {q}^{T} \\ q & Q\end{matrix} ] , [ \begin{matrix}1 & {x}^{T} \\ x & x {x}^{T}\end{matrix} ] 〉 = 〈 W , {Y}_{x} 〉 = 〈 \tilde{w} , \tilde{x} 〉 ,$$
wherein
\tilde{w}=svec(W), \tilde{x}=svec(Yₓ),
wherein an objective function can be written as:
Σᵢ₌₁^{N}( [symbol] \tilde{w},\tilde{x}ⁱ [symbol] −yⁱ)²+μ( [symbol] \tilde{w},\tilde{x}ⁱ [symbol] −gⁱ)², and
wherein the constraints can be written as:
type 1: [symbol] \tilde{w},\tilde{x} [symbol] ≤c₁+β^{T}x, ∀x∈X, and
type 2: [symbol] \tilde{w},\tilde{x} [symbol] ≤c₃, ∀x∈X∩H.
